(19) United States
(12) Patent Application Publication
(10) Pub. No.: US 2008/0294339 A1
(43) Pub. Date: Nov. 27, 2008

(54) Route display apparatus and route display system

(75) Inventors: Nobutaka Tauchi, Toyoake-city (JP); Katsuhari Hosoe, Okazaki-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/153,460

(22) Filed: May 20, 2008

(30) Foreign Application Priority Data
May 24, 2007 (JP) 2007-138051

(51) Int. Cl. G01C 21/36; G06F 19/00

(52) U.S. Cl. 701/212; 701/123

(57) ABSTRACT

A navigation system includes a control circuit that controls scrolling of a navigation route together with economical driving information pertaining to a part of the navigation route on a display unit so as to match a moving point along the navigation route to a standard point of the display unit (e.g., a center of the display), thereby allowing a user of the navigation system to recognize the economical driving information of the navigation route prior to the travel of the navigation route in the course of confirmation of the navigation route and enabling the user to imagine required operation condition of economic driving.

### CROSS REFERENCE TO RELATED APPLICATION

The present application is based on and claims the benefit of priority of Japanese Patent Application No. 2007-138051 filed on May 24, 2007, the disclosure of which is incorporated herein by reference.

### FIELD OF THE INVENTION

The present disclosure generally relates to a navigation apparatus for use in a vehicle.

### BACKGROUND INFORMATION

The navigation system of conventional use is known to assist smooth driving by displaying a current vehicle position on a road map, and/or by setting a navigation route from the current position to a destination and navigating a driver of a vehicle. The navigation system guides the vehicle through the navigation route, for example, by providing a vocal guidance “Turn left 300 meters ahead” or the like prior to approaching an intersection. Further, the navigation system displays a landmark facility such as a gas station, a restaurant or the like on the road map for facilitating a travel of the vehicle based on recognition of the landmark facility.

The information on the road map, facilities or the like is basically provided by a medium such as DVD, HDD, and is also provided through vehicle information services by acquiring various information from the network. The vehicle information services provide, for the navigation system, value added information in various forms by utilizing accumulated information in a server and a high computing capacity of the server.

Among the navigation systems, some system is capable of providing information on energy saving driving on the display unit of the navigation system (refer to a patent document 1:Japanese patent document JP-A-2002-370560). More practically, the display unit of the navigation system includes an indicator unit for indicating an index of an appropriate operation of accelerator and a fuel mileage meter unit for displaying a momentum fuel mileage and a section fuel mileage. The indicator unit informs a vehicle driver of whether his/her acceleration operation is appropriate in terms of fuel mileage based on a condition of acceleration operation.

The navigation systems described above provide various functions such as (1) a driving schedule arrangement function that simulates a driving operation of a navigation route prior to a travel of the navigation route for confirmation and adjustment of driving schedule (refer to a patent document 2:Japanese patent document JP-A-2001-165691), (2) a fuel mileage calculation function that calculates a fuel mileage and a cruising range for a remaining fuel based on a vehicle weight, temperature difference between an outside of the vehicle and an inside of the vehicle, and a vehicle speed upon inputting a temperature change or a vehicle speed change from a touch panel in for a purpose of informing the driver of how the change affect the fuel mileage (refer to a patent document 3:Japanese patent document JP-A-2003-279360, or US patent document 6859720), (3) an actual travel evaluation function that evaluates an actually traveled route against a navigation route provided by the navigation system (refer to a patent document 4:Japanese patent document JP-A-2005-003527), and (4) a warning function that provides a warning of deteriorated travel condition relative to prior travel based on a comparison of travel data and fuel mileage for encouraging the driver of safe driving and/or fuel saving driving (refer to a patent document 5:Japanese patent document JP-A-2006-003147).

However, the navigation system in the patent document 1 described above only considers the acceleration operation of the driver in terms of the fuel mileage. Therefore, the instruction provided by the navigation system may not be applicable for a section of the provided navigation route to be traveled if a road condition is different from the already-traveled section. That is, the driver may have difficulty of imagining an appropriate (mileage conscious) acceleration operation based on the instruction at each section of the navigation route to be traveled even when the instruction is provided prior to the actual travel.

Further, the navigation system in the patent document 2 is not configured to display information on energy save driving. That is, the driver may have difficulty of imagining an appropriate (mileage conscious) acceleration operation based on the instruction at each section of the navigation route to be traveled even when the instruction is provided prior to the actual travel.

Furthermore, the navigation system in the patent document 3 displays the fuel mileage and the cruising range on the display unit without considering the section of the navigation route to be traveled. That is, the driver may have difficulty of imagining an appropriate (mileage conscious) acceleration operation based on the instruction at each section of the navigation route to be traveled even when the instruction is provided prior to the actual travel.

Furthermore, the navigation system in the patent document 4 is configured to evaluate the navigation route at each section of the navigation route without associating the evaluation of the route with the road map and the vehicle position information. That is, the driver may have difficulty of imagining an appropriate (mileage conscious) acceleration operation based on the instruction at each section of the navigation route to be traveled even when the instruction is provided prior to the actual travel.

Furthermore, the navigation system in the patent document 5 is configured to evaluate the navigation route at each section of the navigation route in the same manner as the system in the patent document 4, also without associating the evaluation of the route with the road map and the vehicle position information. That is, the driver may have difficulty of imagining an appropriate (mileage conscious) acceleration operation based on the instruction at each section of the navigation route to be traveled even when the instruction is provided prior to the actual travel.

### SUMMARY OF THE INVENTION

In view of the above and other problems, the present invention provides a technique that enables a user to imagine an appropriate operation of efficient driving at each of points along a navigation route to be traveled prior to an actual travel of the navigation route.

The route display apparatus of the present invention includes: an information acquisition unit capable of acquiring route information and driving support information, wherein the route information determines a specific route and the driving support information contributes to an efficient driving; a display unit capable of displaying various information; and a control unit capable of displaying a route map and scrolling the route map. The route map is partially displayed by the control unit on the display unit for displaying the specific route that is determined based on the route information acquired by the information acquisition unit, and the route map is displayed by the control unit in association with the driving support information acquired by the information acquisition unit. Further, the scrolling of the route map is controlled by the control unit so that a virtual moving point that moves along the specific route and a standard point on the display unit are matched in a course of scrolling the route map.

Therefore, the user, or the vehicle driver, can view driving support information prior to the actual travel of the navigation route, that is, the driver can view the driving support information when the user checks and confirms the navigation route to be traveled, thereby being enabled to imagine an operation condition for efficient driving at each of the points on the navigation route prior to the actual travel.

### BRIEF DESCRIPTION OF THE DRAWINGS

Other objects, features and advantages of the present invention will become more apparent from the following detailed description made with reference to the accompanying drawings, in which:

FIG. 1 shows a block diagram of outline configuration of a navigation apparatus 10;

FIG. 2 shows a block diagram of system configuration to acquiring eco-driving information by using the navigation apparatus 10;

FIG. 3 shows an illustration of outline configuration of a navigation system 1000;

FIGS. 4A and 4B show illustrations of a menu selection screen and a setting screen of on-route scrolling;

FIG. 5 shows an illustration of guidance map when on-route scrolling with eco-guidance is selected;

FIGS. 6A and 6B show illustrations of guidance map of eco-driving information in a large scale route map and in a small scale route map;

FIGS. 7A and 7B show illustrations of an eco-driving support screen and an eco-route search screen;

FIGS. 8A and 8B show illustrations of an eco-route search results display screen and an eco-route data registration screen;

FIGS. 9A and 9B show illustrations of an eco-route registration data search results screen and an eco-driving instruction screen;

FIG. 10 shows a flowchart of eco-driving information acquisition and initialization process;

FIG. 11 shows a flowchart of an eco-driving information display process;

FIG. 12 shows a flowchart of an eco-driving information acquisition process;

FIG. 13 shows a flowchart of an ideal eco-driving data generation process;

FIG. 14 shows a flowchart of a real-time eco-route guidance process; and

FIGS. 15A and 15B show illustrations of an eco-driving guidance screen and an eco-driving instruction screen.

### DETAILED DESCRIPTION

The embodiment which present invention was applied to is explained with the drawing. In addition, the present invention can take various forms including the following embodiment as long as the variation pertains to the technical range of the present invention.

### [Configuration of the Navigation Apparatus 10]

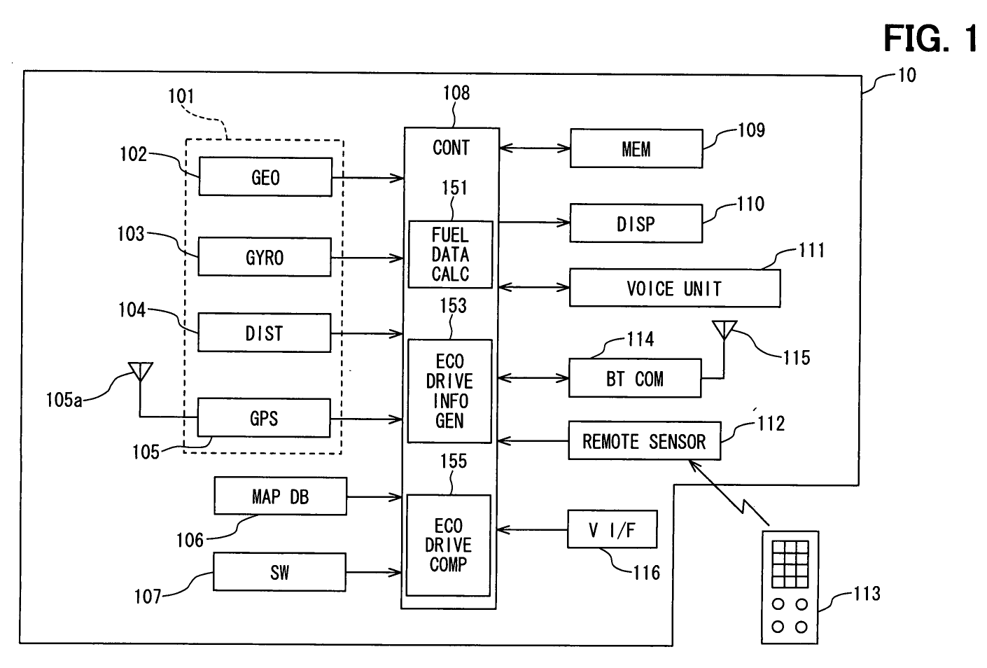

FIG. 1 is a block diagram showing an outline configuration of a navigation apparatus 10 which has the function of the course display unit of the present invention incorporated therein.

The navigation apparatus 10 is disposed on a vehicle, and has the following components. That is, a position sensor 101 detecting the current position of the vehicle, a switch group 107 inputting various instructions from a user, a remote control terminal (designated as a “remote controller” in the following) 113 inputting various instructions in the same manner as the switch group 107 and being in a separate body from the navigation apparatus 10, a remote sensor 112 inputting a signal from the remote controller 113, a BT communications unit 114 having communication with an outside through packet communication network, a vehicle I/F 116 inputting and outputting information from/to other devices in the vehicle in connection thereto, a map database 106 storing map data, audio data and the like, a display unit 110 displaying various information together with a map, a voice unit 111 outputting various guide sounds and the like and outputting an electrical signal based on the sound that is uttered by a user, an external memory 109 memorizing various information in connection with a control circuit 108, and the control circuit 108 performing various processing based on an input from the position sensor 101, the switch group 107, the remote sensor 112, the vehicle I/F 116, the voice unit 111 and the like. The control circuit 108 also performs control on the BT communications unit 114, the vehicle I/F 116, the display unit 110, the voice unit 111 and the like.

The position sensor 101 includes a geomagnetism sensor 102 which detects an absolute direction of the vehicle based on geomagnetism, a gyroscope 103 detecting the degree of rotary motion applied to the vehicle, a distance sensor 104 detecting a travel distance based on an acceleration in a front-rear direction of the vehicle and the like, a GPS receiver 105 receives the electric wave from a GPS (Global Positioning System) satellite through a GPS antenna 105a, and outputs the received signal. The control circuit 108 calculates the position of the vehicle, the direction of the vehicle, the speed of the vehicle based on output signals from the sensors 102-105 and the like. In addition, a current position may be determined based on an output from the GPS receiver 105 by using a point positioning method or a relative positioning method among various positioning methods.

The switch group 107 consists of the mechanical key-switches and the like. The various operation orders from a user are accepted by those switches, and the switch group 107 outputs the accepted orders as an order signal to the control circuit 108.

The remote controller 113 has plural buttons, and is configured to emit a signal that corresponds to a kind of buttons when one of the buttons is pressed, and the signal is transmitted to the remote sensor 112 through a short range wireless communication such as infrared rays.

The remote sensor 112 receives a signal sent from the remote controller 113, and the received signal comes to be output to the control circuit 108. The BT communications unit 114 acquires accident information, traffic jam information or the like from the VICS information center (Japanese traffic information center) propagated by a light beacon or an electric wave beacon installed on the roadside through the antenna 115.

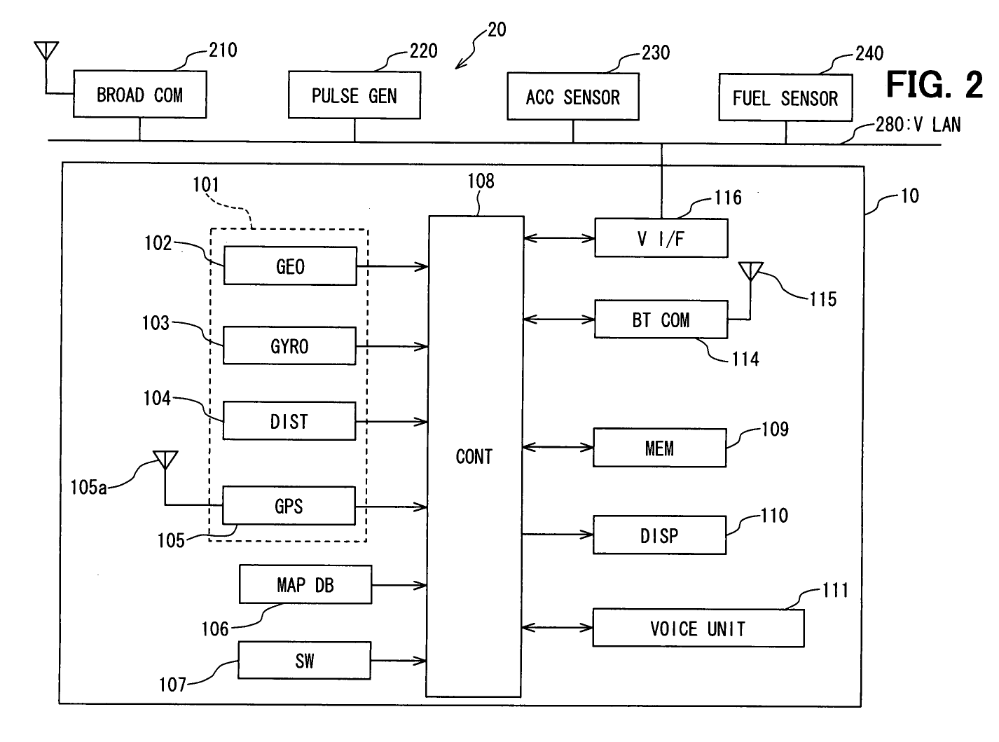

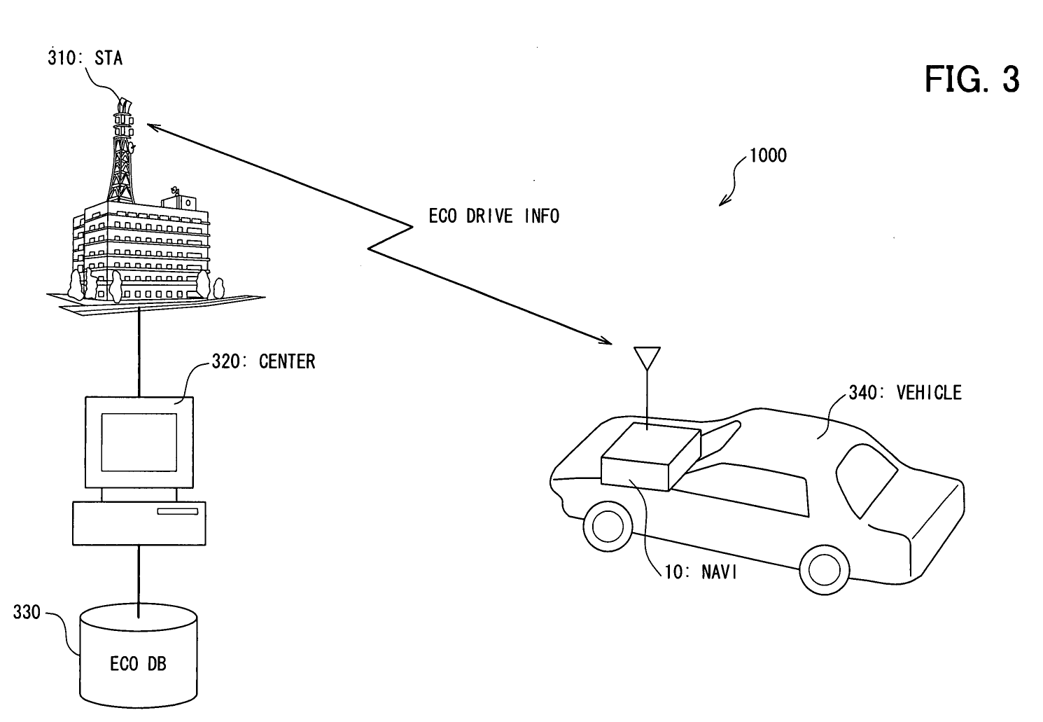

The vehicle interface (I/F) 116 is connected to the other external equipment in the vehicle, and serves a function to input and output information from/to the equipment. In addition, the vehicle I/F 116 is connected to various ECUs (cf. FIG. 2) that are considered as one of the external equipment. By the connection to the ECUs, the vehicle I/F 116 enables data communication with various ECUs through a vehicle LAN 280 (cf. FIG. 2). In addition, the vehicle I/F 116 has a function to obtain eco-driving information from an outside eco-driving information database 330 to be mentioned later (cf. FIG. 3). In this context, the eco-driving information refers to information that contributes to economical driving by the user, and the eco-driving information is equivalent to “the driving support information” in the context of claiming the present invention.

The map database 106 stores map data consisting of the various kinds of information about the map. In the map data, the road is represented by a node set in the middle position of each crossing of the real road and a link to connect the nodes. In other words, the road in the map data is managed by a unit of link, and each of the links are connected to other link by the node at its end. Further, a link ID (a road identifier) that is a peculiar identifier is given to each of the links, and the link can be identified by the link ID. The “crossing” is, in this case, a spot that defines a connecting point of plural roads, that is, the crossroads, T-shaped roads, branch points, junctions and the like. In other words, the “crossing” is a point where at least three links are connected one node. In addition, node data, the link data and the like are equivalent to “route information” in the context of claiming the present invention.

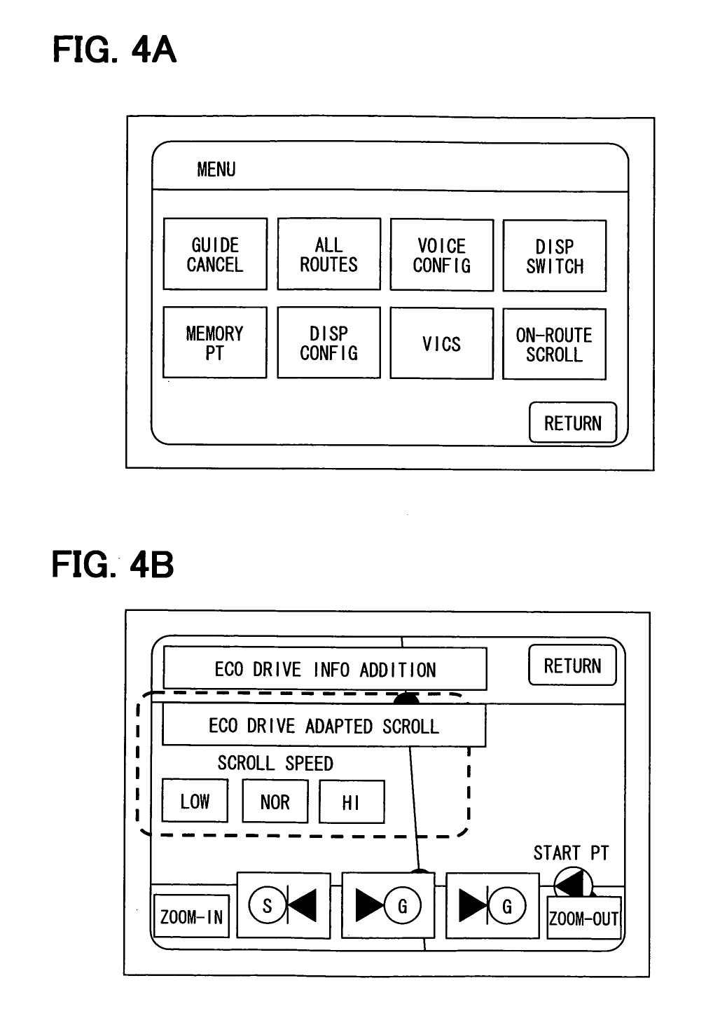

The display unit 110 uses a liquid crystal display, an organic electroluminescence display or the like to display a current position mark that is determined based on the present vehicle location detected by the position sensor 101 and the map data retrieved from the map database 106 together with a route to the destination, land names, landmarks, various facility marks in a superposing manner. In addition, the display unit 110 can also display the guides of the facilities. Further, the display unit 110 performs a screen display and guidance to instruct the eco-driving by “on-route scroll” shown in FIGS. 4A to 9. In addition, the eco-driving is defined as economical driving from a viewpoint of fuel consumption. Further, the operation of the eco-driving instruction by the on-route scroll is performed by operating the switch group 107, a touch panel disposed on the display unit 110 or the remote controller 113.

In addition, the display unit 110 is equivalent to the display unit in the claiming context.

The voice unit 111 can output vocal guidance of a facility retrieved from the map database 106 and other guidance. In addition, the voice unit 111 outputs an electrical signal (a voice signal) based on the input sound when a user inputs (i.e., utters) a sound to the control circuit 108. The user can operate the navigation apparatus 10 by inputting various voices to the voice unit 111.

The external memory 109 uses a non-volatile memory to memorize various data such as eco-driving information or the drive operation history information. Regarding the eco-driving, the information includes, by a unit of roads, links or predetermined sections, averaged fuel mileage data, averaged acceleration, travel time as well as an abrupt acceleration/deceleration point, a data measurement date/time, and the like. Further, because the eco-driving information is collected by a unit of eco-driving acquisition/registration in both of the stored eco-driving information in the memory 109 in the past and selected eco-driving information for comparison, data is easily compared with each other. Furthermore, the drive operation history information includes travel routes, positional information, the actual fuel mileage, date and time, averaged speed, averaged acceleration and deceleration, fuel consumption, travel distance, travel time, shift positions, accelerator opening, engine rotation, accumulation power consumption, the number of the passengers, loading weight, temperature, atmospheric pressure, oxygen density, and the wind velocity.

In addition, the external memory 109 is equivalent to the information storage unit in claiming context.

The control circuit 108 uses a microcomputer including a CPU, a ROM, a RAM, an SRAM, an I/O and a bus line connecting these components, and performs various processing based on a program stored in the ROM/RAM. For example, the current position of the vehicle is calculated as a set of coordinates and a travel direction based on each of detection signals from the position sensor 101 to perform a current position display process for displaying a current position on a neighborhood map that is retrieved from the map database 106 on the display unit 110, and an optimum navigation route from the current position to the destination is calculated by a route calculation process based on the map data in the map database 106 and an inputted destination according to the operation of the switch group 107, the remote controller 113 or the like. Further, a route guidance process is performed to display the navigation route for guidance purpose and to output vocal guidance of the route from the voice unit 111 with other processes.

In addition, the control circuit 108 includes a mileage data calculation unit 151 to calculate fuel mileage data, an eco-driving guidance information generation unit 153 to provide eco-driving instruction/guidance, and an eco-driving information comparison unit 155 to provide eco-driving evaluation as well as displaying evaluation result and/or instructions based on a comparison between downloaded eco-driving information, eco-driving information registered in the past and current eco-driving information for the purpose of supporting the eco-driving. In addition, the control circuit 108 generates the above-mentioned drive operation history information at scheduled intervals for storing in the external memory 109.

In addition, the control circuit 108 requests the center 320 to generate on-route scroll data as required. At the time of the request, the control circuit 108 may attach additional information such as the number of the passengers, the loading weight or the like besides the route information. As for the on-route scroll data, the contents of the data are used to represent economical driving operation in terms of driving through the navigation route. In addition, when the control circuit 108 receives transmitted information from the center 320 in response to the request, the received information is stored in the external memory 109 or is displayed on the display unit 110 under the control of the control unit 108.

The control circuit 108 is equivalent to the information acquisition unit in claiming context.

### [Eco-Driving Information Acquisition and Collection by the Navigation Apparatus 10]

Technique how the navigation apparatus 10 obtains and collects the eco-driving information is explained in the following. FIG. 2 shows a system configuration block diagram of the navigation apparatus 10 that obtains and collects the eco-driving information. In addition, FIG. 3 shows an illustration explaining an outline configuration of the navigation system 1000.

The navigation apparatus 10 is connected to various sensors (a vehicle speed pulse generator 220, an acceleration sensor 230, a fuel quantity sensor 240 and the like) and a broad range communications unit 210 to communicate with a center 320 to be mentioned later through a vehicle LAN 280 by way of the vehicle I/F 116 as shown in FIG. 2. In addition, watching the measurement time is necessary when the navigation apparatus 10 collects, generate and memorizes the eco-driving information. Therefore, the measurement time may be acquired as time data from a clock that is not shown in the figure, or as the time data that is determined when the GPS receiver 105 is used to detect the position, or in a similar manner. In addition, the average speed and the average acceleration of the vehicle 340 may be calculated based on the signal from the vehicle speed pulse generator 220 and the GPS receiver 105, or may be measured by using the acceleration sensor 230 or the gyroscope 103rd.

In addition, the navigation apparatus 10 conducts data communication with the center 320 through the broad range communications unit 210 and the telephone network base station 310, and confirms the accumulation situation of the eco-driving information in the eco-driving information database (eco-DB) 330 as shown in FIG. 3, or searches the eco-driving information from the eco-driving information database 330, or acquires the eco-driving information from the eco-driving information database 330. In addition, the center 320 and the eco-driving information database 330 are equivalent to an information center in claiming context. In addition, the navigation apparatus 10, the center 320 and the eco-driving information database 330 constitutes the navigation system 1000. The navigation system 1000 is equivalent to a route display system in the claiming context.

In addition, the eco-driving information that the eco-driving information database 330 memorizes is memorized for every link, and, in each of eco-driving information includes a road link number, a speed limit, an ideal average speed, an ideal fuel consumption, travel distance, incline information, road classification information. In addition, the eco-driving information that is memorized by the eco-driving information database 330 and the eco-driving information that is memorized by the external memory 109 of the navigation apparatus 10 memorize have respectively different information included therein.

When car model information and information of route search results are obtained from the navigation apparatus 10 in the center 320, an ideal vehicle movement pattern on the route is generated, and an ideal eco-driving data generation process (to be mentioned) for realizing the movement pattern and a real time eco route guidance process (to be mentioned) are performed by using a prefixed ideal average acceleration/deceleration, an ideal deceleration for shifting down, and an ideal corner driving speed and the like based on a speed limit, an the average speed and incline information included in the eco-driving information of every memorized link.

The data memorized for every link described above stores numerical values when the driving state of the vehicle is ideal. When occupants number information representing the number of the occupants, loading weight information representing the weight of the load and the like are additionally transmitted from the navigation apparatus 10 as data, the vehicle movement pattern is modified by additionally considering those information.

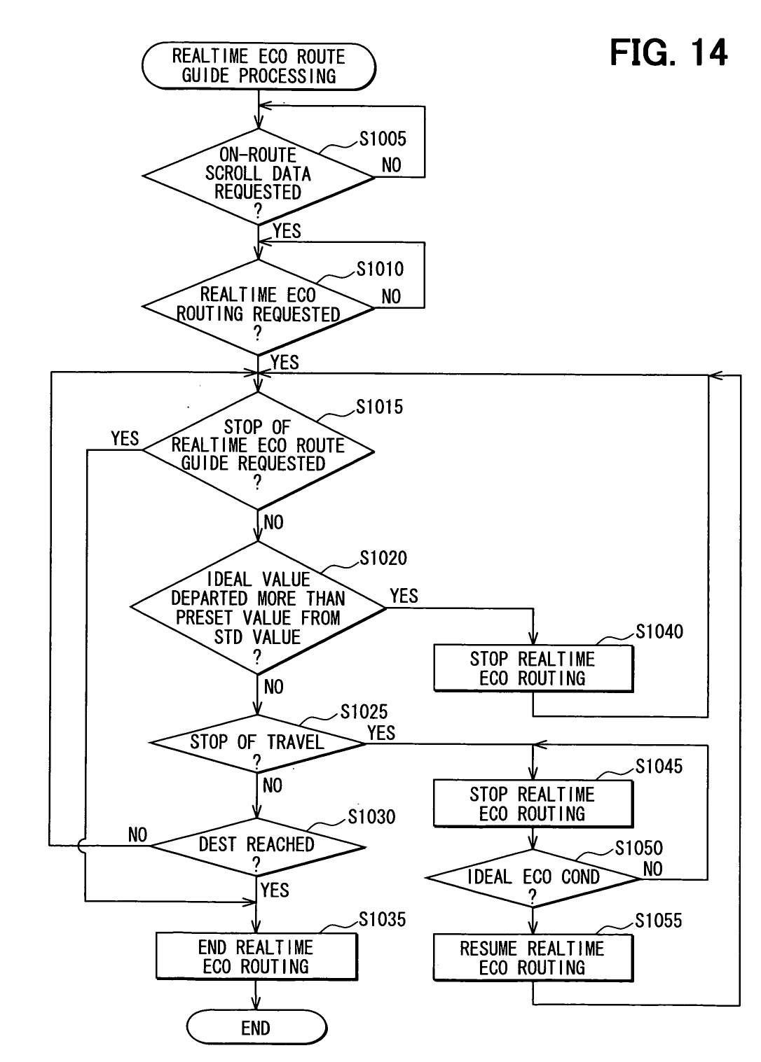

In addition, temperature, atmospheric pressure, oxygen density, wind velocity, traffic jam situation of each of the areas collected at the center 320 may be added for generating the vehicle movement pattern (cf. refer to a flowchart of FIG. 14). In addition, after performing the above process in the center 320, the navigation apparatus 10 obtains vehicle movement pattern (the drawing pattern of the own position mark) information, an eco-guidance symbol and drawing position information of the symbol for performing eco on-route scroll on the navigation apparatus 10.

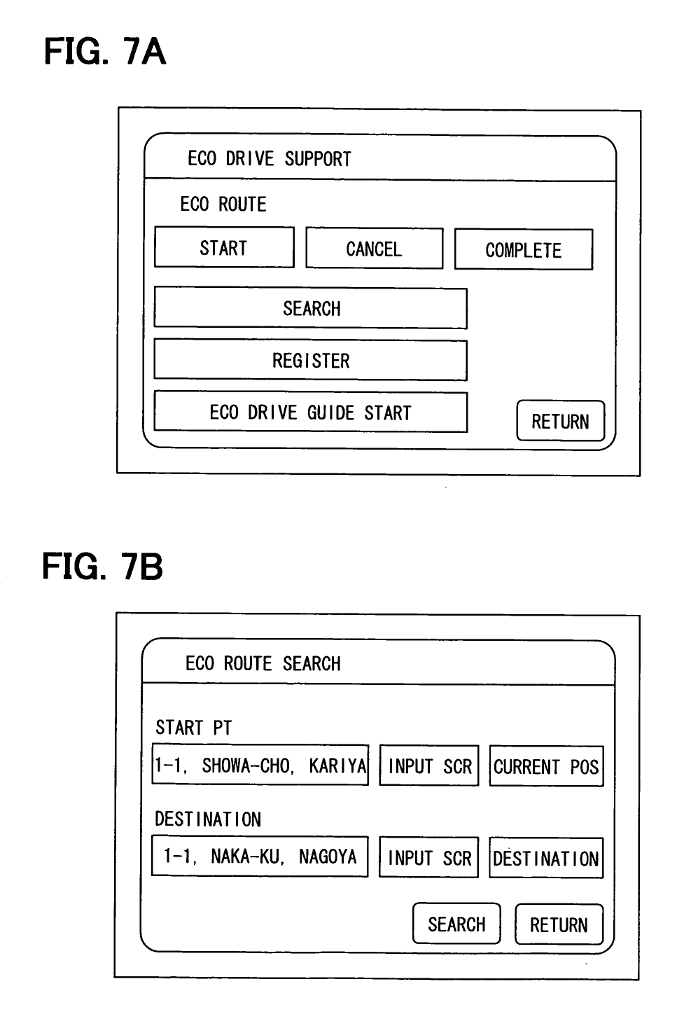

In addition, besides the calculation of the ideal vehicle movement pattern, the calculation of the vehicle movement pattern of an actual vehicle according to travel data which is registered in an “eco-route data registration screen” as shown in FIG. 7B and the calculation of eco-guidance symbol based on the calculated movement pattern may be performed in the center 320. In the case, the vehicle data transmitted from the navigation apparatus 10 is used as the movement data as it is, and only the eco-guidance symbol based on the movement condition is generated. In the case, the vehicle stopping state is also reflected to a driving state. In addition, the processing of calculation of the vehicle movement pattern is performed in the center 320 in the above example, an entire processing of calculation may be performed in the control circuit 108 of the navigation apparatus 10.

### [On-Route Scroll Processing]

FIGS. 4A to 9 are referred to for an explanation of an on-route scroll process by the control circuit 108 of the navigation apparatus 10 in the following.

First, the display unit 110 displays a menu selection screen exemplified as shown in FIG. 4A. Instruction and guidance of the eco-driving by the on-route scroll are performed, in the case, when an on-route scroll button in the menu selection screen is touched. Upon touching the menu screen, the display unit 110 displays a setting screen exemplified as shown in FIG. 4B. The setting screen has an “eco-driving information addition” button to add the eco-driving information in synchronization with on-route scroll. When the “eco-driving information addition” button is not pushed down, only the on-route scroll is carried out. On the other hand, a “Low” button, a “Nor” button, and a “Hi” button for setting a scroll speed are displayed when the “eco-driving information addition” button is pushed down.

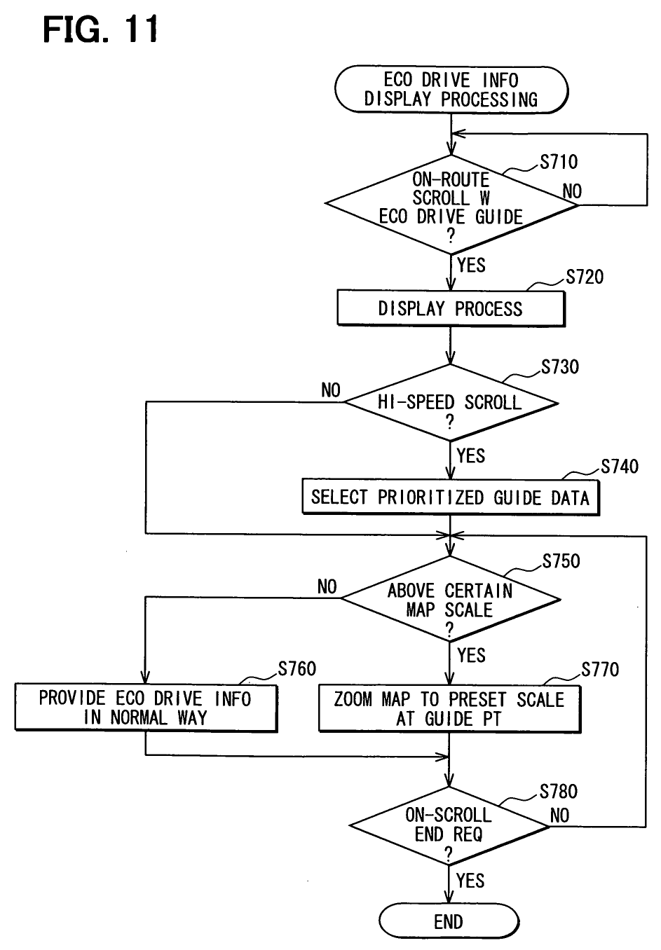

When an “eco-driving adapted scroll” button is pushed down, “display processing to provide eco-driving information” that scrolls the position of the vehicle according to the average speed and acceleration of the eco-driving information of the point is carried out (corresponding to S720 of FIG. 11).

An example of the above-described situation is given in the following. That is, when a navigation route that has the distance to a set destination of 60 km and the estimated travel time of 1 hour along the route to the destination is scrolled in 1 minute by a normal on-route scroll, the average of the vehicle speed of the case is 60 km/h, and the vehicle position mark moves at the speed of 3,600 km/h. Based on the above calculation, the vehicle position mark scrolls at the speed of 1,800 km/h when an eco-driving at 30 km/h average speed is required. Or, the vehicle position mark scrolls at the speed of 7,200 km/h when an eco-driving at 120 km/h average speed is required.

In addition, the “Low” button, the “Nor” button and the “Hi” button to set the scroll speed are provided to coordinate the scroll speed of the screen (the scroll speed of the position of the vehicle mark) in three phases.

Further, there are generally 4 buttons on the on-route scroll screen, that is, a jump button to the destination, a scroll start button from the departure place to the destination, a scroll start button to the departure place, and a scroll start button from the destination to the departure place. When the eco-driving guidance is provided during the on-route scroll, only three buttons of a jump button to the destination, a scroll start button from the departure place to the destination, and a scroll start button to the departure place are displayed, because a scroll start button from the destination to the departure place is not required.

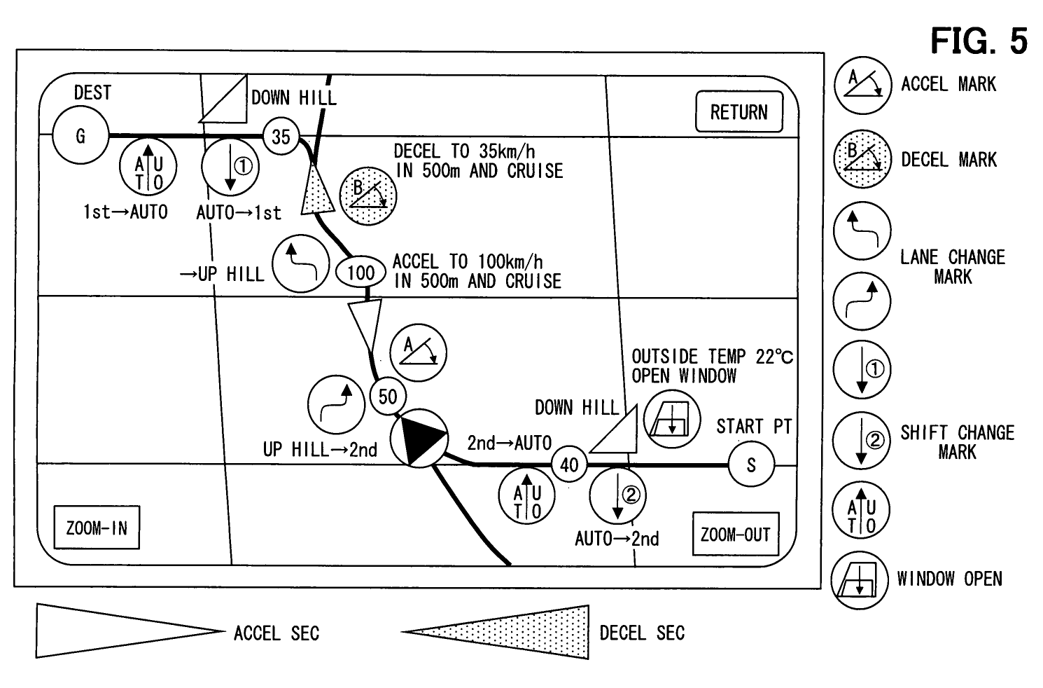

When the on-route scroll with the eco-guidance is selected, the display screen of a guidance map exemplified as shown in FIG. 5 is displayed on the display unit 110 in the case. On the display screen of the guidance map, “eco-guidance symbols” of an acceleration mark, a deceleration mark, a lane-changing mark, a shift position change mark, a window opening and closing mark, an uphill slope/downhill slope mark, a speed mark, an acceleration section/deceleration section are displayed besides the departure place, the destination and the searched route after destination setting/the route search for displaying eco-driving instructions.

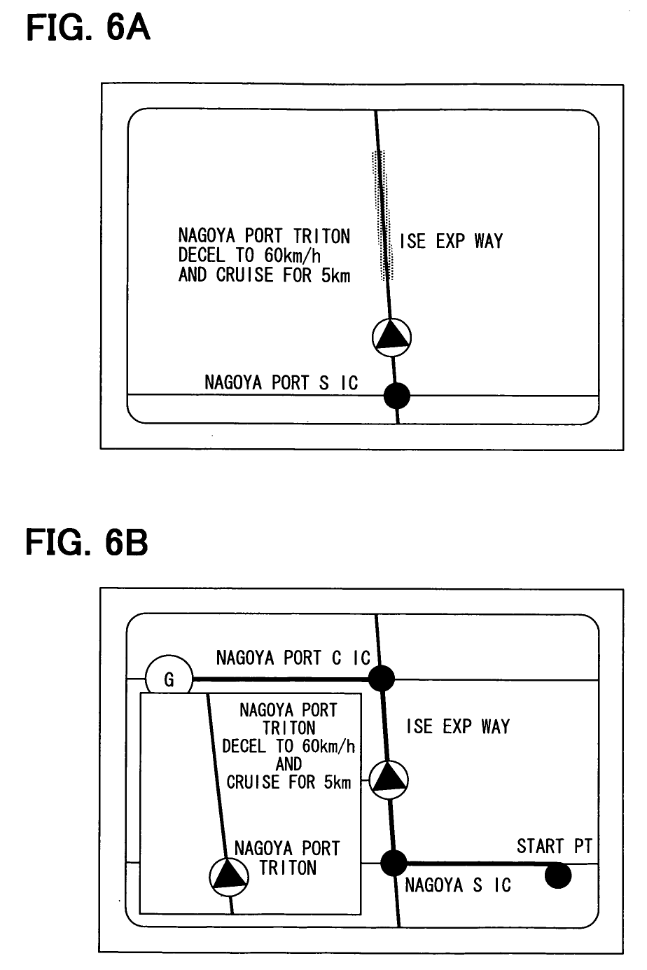

A guidance screen of eco-driving information exemplified as shown in FIG. 6A is displayed on the display unit 110 in the case when the scale of the guidance map is large. The color of a portion of a navigation route in the road map (i.e., a road section) where eco-driving is particularly required is changed for display purpose, and instruction contents of the eco-driving are guided by a text display (average speed per hour, acceleration/deceleration information) and by a sound.

On the other hand, a guidance screen of eco-driving information exemplified as shown in FIG. 6B is displayed on the display unit 110 when the scale of the guidance map is small. When the position mark approaches the vicinity of eco-driving guidance point in the display screen, a detailed drawing is displayed for guidance, or the scale of the guidance map is increased. In addition, a method of the guidance of the eco-driving may be changed according to the scroll speed of the on-route scroll as described above. That is, for example, when the speed of the on-route scroll is fast, only a high priority point (the points where the fuel mileage may extremely deteriorate depending on the driving operation) is guided under the control.

By the way, an eco-driving support screen exemplified in FIG. 7A is started when the operation switch group 107 of the navigation apparatus 10 or a predetermined button of the touch panel implemented on the display unit 110 are pushed down. The eco-driving support screen is intended to compare the eco-driving information downloaded from the eco-driving information database 330 and the eco-driving information registered in the past with the current eco-driving information, and to carry out an evaluation and evaluation result display of the eco-driving, and to guide the eco-driving instruction.

When an “eco-route search screen” button in the eco-driving support screen is pressed, the screen shifts to an eco-route search screen exemplified in FIG. 7B. The search of an eco-route based on a destination or a searched route which is previously set is provided by the eco-route search screen. The search is performed on the storage area of the external memory 109 of navigation apparatus 10 or on the eco-driving information database 330.

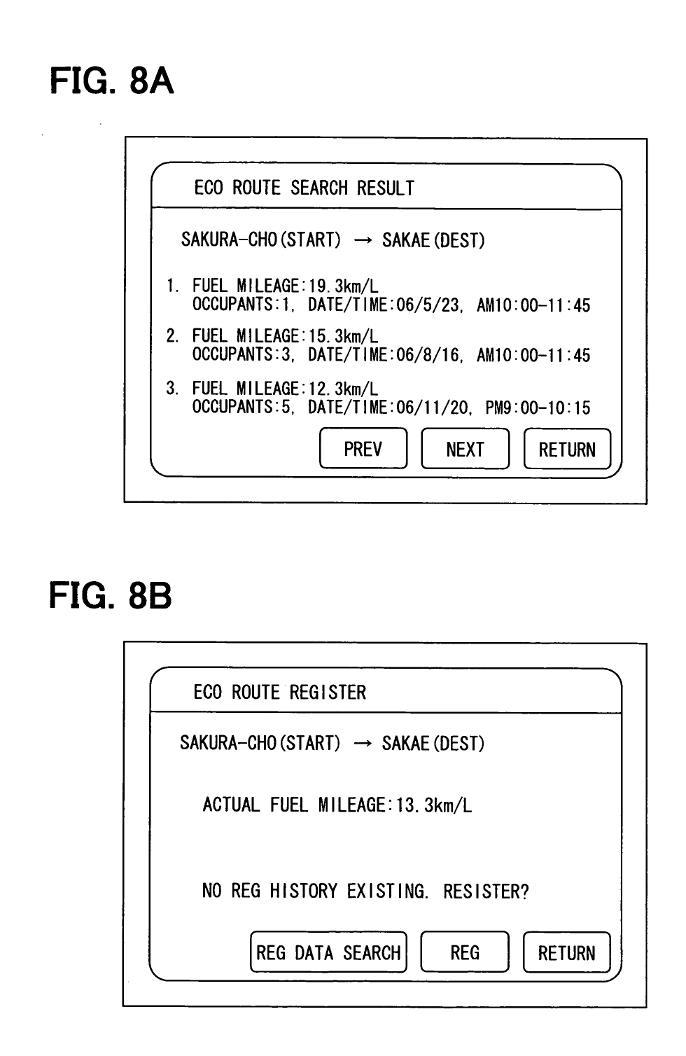

In addition, the display screen of the search results of an eco-route exemplified as shown in FIG. 8A is displayed on the display unit 110 when the search button of the eco-route search screen is pushed down. Furthermore, selected eco-driving (an eco-route) information is acquired from the eco-driving information database 330 when a search results display button on the display screen of the eco-route search results is selected.

When collection and registration of the eco-driving information are performed, a “Start” button of the eco-driving support screen exemplified as shown in FIG. 7A is pushed down for starting the information collection. In addition, a “Complete” button should be pushed down when collection of the eco-driving information is terminated. Further, when a “Register” button is pressed for registration of the collected eco-driving information is performed, an “eco-route registration screen” in FIG. 8B is displayed on the display unit 110, and a “REG” button in the registration screen is pressed for storing the collected eco-driving information to the external memory 109 of the navigation apparatus 10.

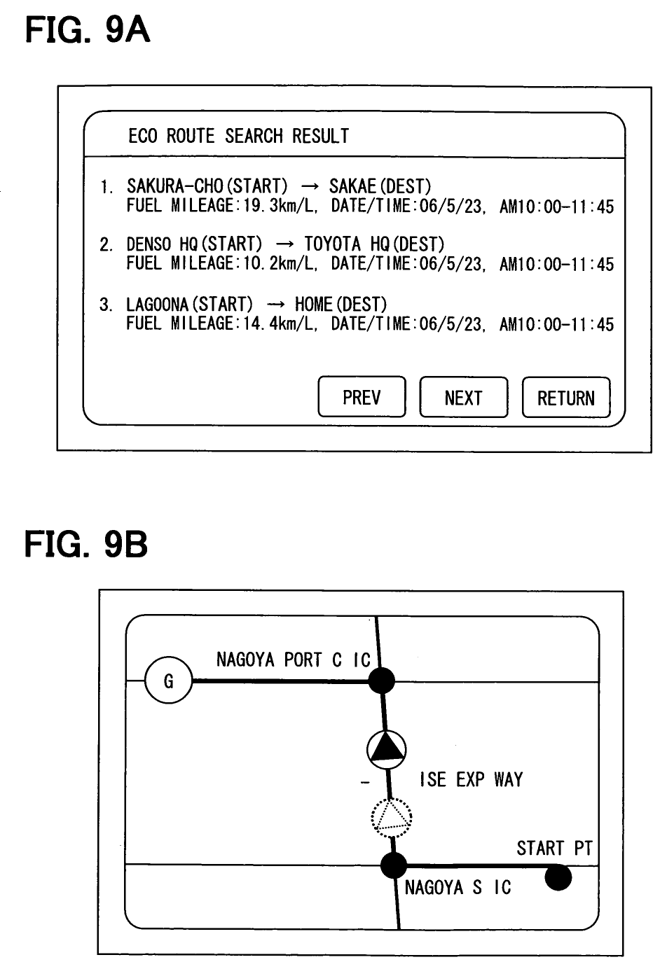

In addition, the registration screen of the eco-route data exemplified in FIG. 8B has a “registration data search” button is provided, and the “registration data search” button is pushed down for displaying the search result of the eco-route registration data on the display unit 110 as shown in FIG. 9A. Then, the list of the eco-route data registered in the past to the external memory 109 of the navigation apparatus 10 is displayed on the screen, and the screen allows a user to select the registration data from the list. When the eco-route registration data is selected, the eco-driving support screen exemplified in FIG. 7A is shown on the display unit 110 again. When the “eco-driving guidance start” button of the eco-driving support screen is pushed down, a display screen of the guidance of the eco-driving in FIG. 9B is displayed on the display unit 110, and instruction of the eco-driving is started. In this case, both of a vehicle mark according to standard eco-driving information and a vehicle position mark according to an actual measurement are displayed, to contrast the difference of the driving operation between the two conditions. In addition, when information of stopping vehicle at a traffic signal or the like is included in the eco-driving information or in a similar situation, scrolling display may be performed after deleting the data of the stopping portion.

### [Acquisition and Initialization of Eco-Driving Information]

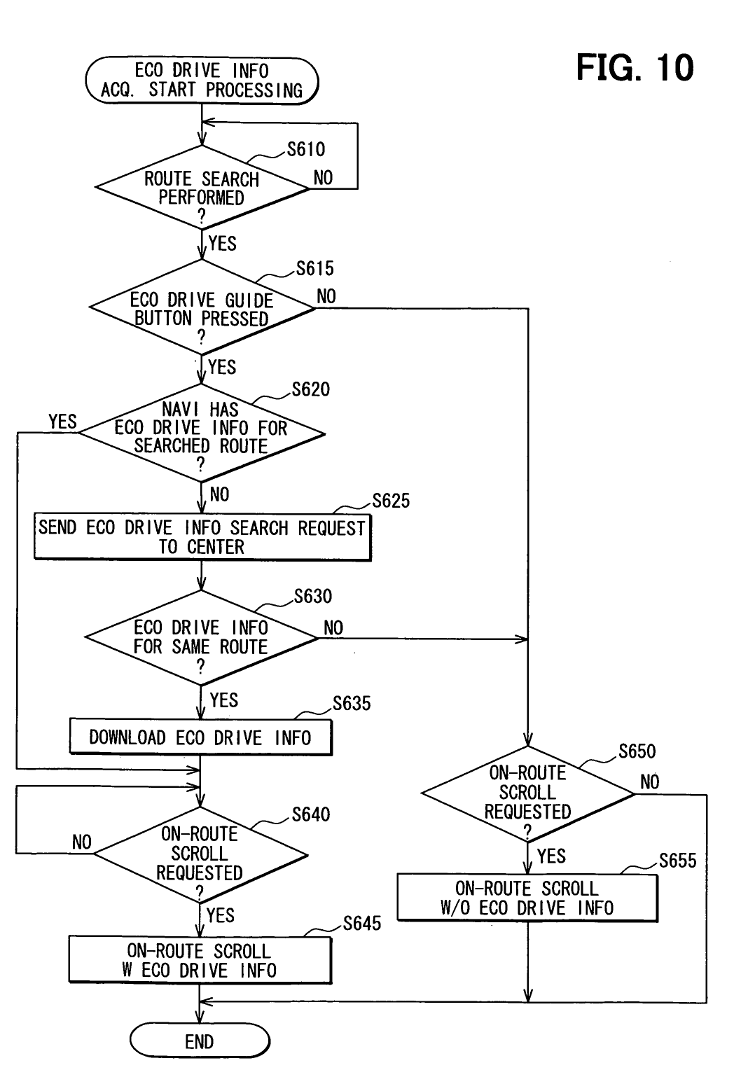

A flowchart of FIG. 10 is referred to for an explanation of acquisition/initialization of the eco-driving information that is performed by the control circuit 108 of the navigation apparatus 10. In addition, explanation about the general processing (route calculation processing or route guidance process) that the control circuit 108 carries out is omitted.

The acquisition/initialization of the eco-driving information are a part of the above-mentioned on-route scroll processing, and the acquisition/initialization processing are repeatedly executed when an ignition key of the vehicle 340 is operated by a vehicle driver to be positioned to an accessories feeding (ACC) by the control circuit 108 of the navigation apparatus 10 independently from other processing.

First, the process determines whether destination setting or the route search is carried out in route calculation processing (S610). Then, the process waits until destination setting or the route search is carried out (S610:NO), and after it is determined that destination setting and the route search is carried out (S610:YES), the process determines whether the “eco-driving guidance” button in the eco-driving support screen in FIG. 7A is pressed (S615). When it is determined that the “eco-driving guidance” button is not pushed down (S615:NO), the process determines whether there is a request of carrying out on-route scroll (S650). When it is determined that a request of carrying the on-route scroll (S650:YES), the on-route scroll is started without guiding the eco-driving information (S655), and the processing is finished. On the other hand, the processing is just finished when it is determined that there is not a request of carrying out the on-route scroll (S650:NO).

On the other hand, the process determines whether the eco-driving information is saved in the storage area of the external memory 109 of the navigation apparatus 10 (S620) when it is determined in S615 that the “eco-driving guidance” button in the eco-driving support screen is pushed down (S615:YES). When it is determined that the eco-driving information is not stored in the storage area of the external memory 109 of the navigation apparatus 10 (S620:NO), request information of the eco-driving information search is transmitted to the center 320 (S625). Then, the process determines whether there is the eco-driving information of the same route in the search results (S630). When it is determined that there is not the eco-driving information of the same route in the search results (S630:NO), the process proceeds to S650. On the other hand, when there is the eco-driving information of the same route in the search results (S630:YES), the eco-driving information is downloaded from the database 330 (S635), and the information is displayed on the display unit 110 in the display screen of the search results shown in FIG. 8A, and the process waits until there is a request of carrying out the on-route scroll (S640:NO). When there is a request of carrying the on-route scroll (S640:YES), the on-route scroll is performed while guiding the eco-driving information (S645). Then, the present processing is finished.

In addition, the process is executed in the following manner when the collected eco-driving information is registered during the on-route scroll. That is, when the “eco-route registration screen” button is pressed as stated above, the eco-route data registration screen is displayed on the display unit 110 as shown in FIG. 8B, and upon pressing the “registration” button of the eco-route data registration screen is pushed, the eco-driving information collected in the above-described manner is memorized to the external memory 109 of the navigation apparatus 10. In addition, the display screen of the search results of the eco-route registration data is displayed on the display unit 110 as shown in FIG. 9A when a “registration data retrieval” button of the registration screen of the eco-route data is pushed down as shown in FIG. 8B. When the eco-route registration data on the display screen of the search results of the eco-route registration data is selected, an eco-driving support screen in FIG. 7A is shown on the display unit 110 again. When the “eco-driving guidance start” button of the eco-driving support screen is pushed down, a display screen of the guidance of the eco-driving is displayed on the display unit 110 as shown in FIG. 9B, and guidance of the eco-driving is started. In this case, a vehicle mark according to the standard eco-driving information and a vehicle position mark according to the actually measured eco-driving information are displayed in a superposing manner. In addition, when information on the stopping of the vehicle at a stop sign of the traffic signal or the like is included in the above-mentioned eco-driving information, the data of the stopping portion may be deleted at the time of scroll for scrolling the map display.

On the other hand, when it is determined that the eco-driving information is saved in the storage area of the external memory 109 of the navigation apparatus 10 (S620:YES), the display screen of the search results of the eco-route in FIG. 8A is displayed on the display unit 110, and the process proceeds to the above-mentioned S640 as it is.

### [Display Processing of Eco-Driving Information]

A flowchart in FIG. 11 is referred to for describing the display processing of the eco-driving information that the control circuit 108 of the navigation apparatus 10 carries out.

When the display processing of the eco-driving information includes above-mentioned on-route scroll processing, and the processing is repeatedly executed independently from other processing by the control circuit 108 the navigation apparatus 10 when the ignition key of the vehicle 340 is operated by a vehicle driver to be put in a position of the accessories feeding (ACC).

That is, in the acquisition/initialization of the eco-driving information, the process determines whether there is a request for the on-route scroll during the guidance of the eco-driving information (S710). More practically, when affirmative determination is performed in S640 of the acquisition/initialization processing of the eco-driving information while the display unit 110 displays a menu selection screen as shown in FIG. 4A, the process determines that there is a request for the on-route scroll while providing the eco-driving information. Then, the process waits until there is a request for performing the on-route scroll while providing the eco-driving information (S710:NO), and after determining that there is a request for the on-route scroll (S710:YES), the display processing to offer the eco-driving information is carried out (S720, cf. FIG. 5). The process displays a setting screen as shown in FIG. 4B on the display unit 110, and the processing is actually carried out when the “eco-driving adapted scroll” button is pushed down. More practically, when the “eco-driving adapted scroll” button is pushed down, the position of the self vehicle is scrolled according to the average speed and the acceleration of the eco-driving information of the spot.

Next, the process determines whether a high-speed on-route scroll setting has been performed (S730). When it is determined that the high-speed on-route scroll setting has been performed (S730:YES), the guidance/displayed data of the high priority are selected (S740), and the process proceeds to S750. On the other hand, when it is determined that the high-speed on-route scroll setting is not performed (S730:NO), the process proceeds to S750 without carrying out S740.

Then, the process determines whether the scale of a map (e.g., a route map) displayed on the display unit 110 is equal to or greater than a predetermined value (S750). When it is determined that the scale of the map displayed on the display unit 110 is equal to/greater than the predetermined value (S750:YES), the above-mentioned map is enlarged to the predetermined scale at the guidance/display point (S770, cf. FIG. 6A), and the process proceeds to S780. On the other hand, when it is determined that the scale of the map on the display unit 110 is smaller than the predetermined value (S750:NO), the eco-driving information is provided in a normal method (S760, cf. FIG. 6B), and the process proceeds to S780.

Then, the process determines whether there is information on a request for ending the on-route scroll (S780). When it is determined that there is information on the request for ending the on-route scroll (S780:NO), the process returns to S750. On the other hand, the processing finishes itself when it is determined that there is information on the request for ending the on-route scroll (S780:YES).

### [Acquisition of Eco-Driving Information]

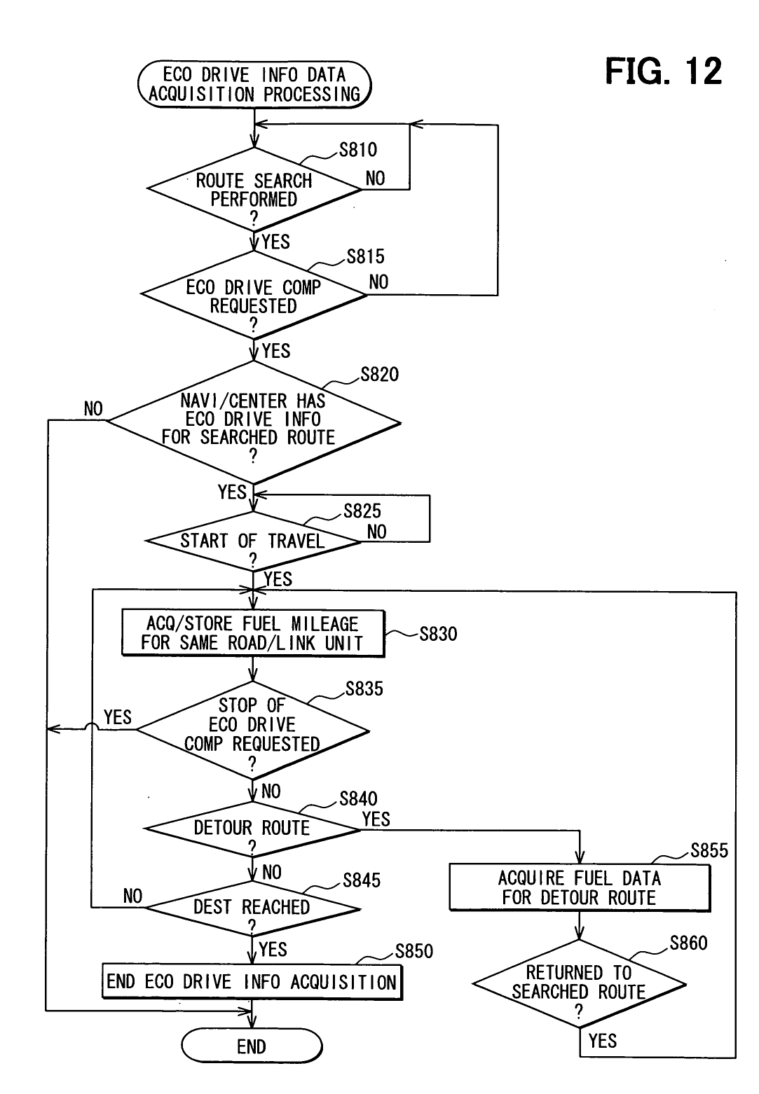

A flowchart of FIG. 12 is referred to for describing the acquisition of the eco-driving information that the control circuit 108 of the navigation apparatus 10 carries outs.

The acquisition of the eco-driving information acquires the eco-driving information such as the fuel mileage at the time of a travel of the vehicle 340, for accumulating the information to the external memory 109. The process is carried out by the control circuit 108 of the navigation apparatus 10 independently from other processing such as the on-route scroll processing when the ignition key of the vehicle 340 is operated by a vehicle driver to be put in a position of the accessories feeding (ACC).

That is, the process first determines whether destination setting or route search has been carried out in the route calculation processing or the like (S810). Then, the process waits until the destination setting or the route search is carried out (S810:NO), and the process determines whether there is a request for comparing the eco-driving (S815) when it is determined that the setting or the route search has been carried out (S810:YES). When it is determined that there is not a request for comparing the eco-driving (S815:NO), the process returns to S810. On the other hand, it determines whether the eco-driving information of the searched section is saved in the storage of the external memory 109 of the navigation apparatus 10 or the storage of the eco-driving information database 330 (S820) when it is determined that there is a request for comparing the eco-driving (S815:YES). When it is determined that the eco-driving information of the searched section is saved in the storage the external memory 109 of the navigation apparatus 10 or the storage of the eco-driving information database 330 (S820:NO), the processing is finished.

On the other hand, when it is determined that the eco-driving information of the searched section is saved in the storage of the external memory 109 of the navigation apparatus 10 or the storage of the eco-driving information database 330 (S820:YES), the process waits for a start of the travel of the vehicle 340 (S825:NO), and the fuel mileage information is acquired for the same road or for the same link of the eco-driving information as a comparison object for storing the information to the storage of the external memory 109 (S830) when the start of the travel of the vehicle 340 is determined (S825:YES). And it determines whether it is demanded to cancel a comparison diagnosis of the eco-driving (S835). When it is determined that it is requested to cancel a comparison of the eco-driving (S835:YES), the processing is finished.

On the other hand, when it is not determined to cancel the comparison of the eco-driving (S835:NO), the process determines whether the vehicle 340 travels out of the navigation route (S840). When it is determined that the vehicle 340 does not travel out of navigation route (S840:NO), the process proceeds to S845 to be mentioned later, or the process proceeds to S855 to be mentioned later when it is determined that the vehicle 340 travels out of the navigation route (S840:YES). Then, the process determines whether the vehicle 340 has arrived at the destination in S845. When it is determined that the vehicle 340 has not arrived at the destination (S845:NO), the process proceeds to S830. On the other hand, when it is determined that the vehicle 340 has arrived at the destination (S845:YES), the acquisition of the eco-driving information data is finished (S850), and the processing is finished.

The fuel mileage data of the portion that the vehicle 340 travels out of the navigation route is acquired in S855. In addition, when the vehicle 340 travels out of the navigation route for more than a predetermined time, the process may carry out re-search of the eco-driving information. Then, the process determines whether the vehicle 340 has returned to the navigation route (S860). When it is determined that the vehicle 340 has not returned to the navigation route (S860:NO), the process returns to S855. On the other hand, the process proceeds to S830 when it is determined that the vehicle 340 has returned to the navigation route (S860:YES).

### [Generation of Ideal Eco-Driving Data]

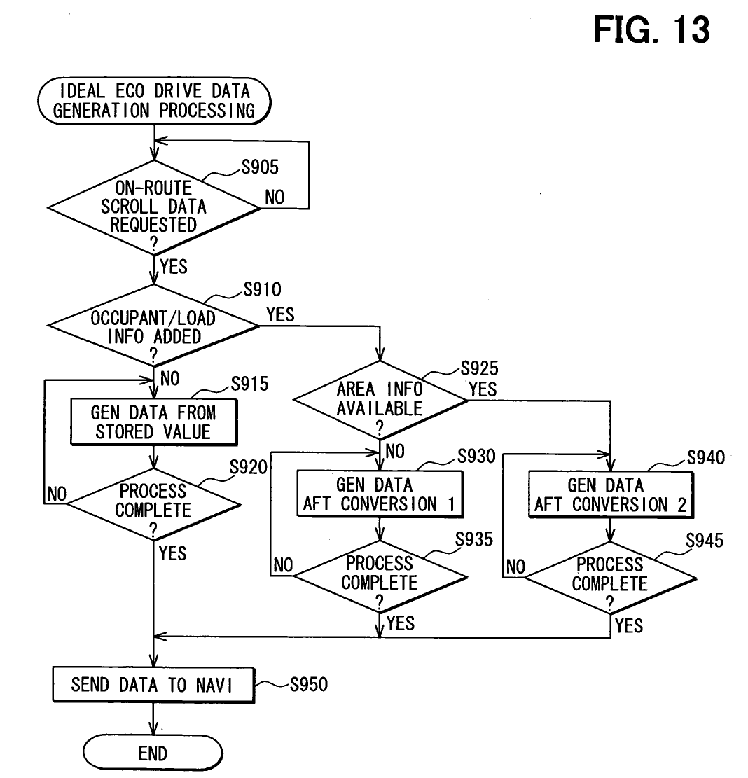

A flowchart in FIG. 13 is referred to for explaining the generation of an ideal eco-driving data which the center 320 carries out. The processing of the generation of the ideal eco-driving data is repeated when the center 320 has electricity supply.

The process first determines whether it is requested to make the on-route scroll data from the navigation apparatus 10 (S905). The on-route scroll data is the data to show a driving procedure to realize an efficient driving regarding the fuel mileage or the like when a navigation route is calculated and provided. The process waits until it is requested to make the on-route scroll data from the navigation apparatus 10 (S905:NO), and upon determining that a request for generating the on-route scroll data from the navigation apparatus 10 (S905:YES), the process determines whether additional information such as the number of the passengers, the loading weight or the like besides the route information is attached to the request (S910). When it is determined that the additional information such as the number of the passengers, the loading weight or the like besides the route information is not attached (S910:NO), the process proceeds to S915 that is to be mentioned later. On the other hand, the process proceeds to S925 that is to be mentioned later when it is determined the additional information such as the number of the passengers, the loading weight besides the route information is attached to the request (S910:YES).

In S915, the on-route scroll data and eco-guidance symbol layout data is generated according to an ideal value memorized in the eco-driving information database 330. Then, the process waits until the processing is completed (S920), and the data is transmitted to the navigation apparatus 10 (S950) after the processing is finished (S920:YES), and the processing is finished.

The process determines whether environmental information of every area is available in S925. The environmental information is the information that shows the circumference environment of the vehicle such as temperature, atmospheric pressure, oxygen density, the wind velocity and the like. When it is determined that the environmental information of every area is not available (S925:NO), a memorized ideal value in the eco-driving information database 330 is converted based on the additional information, and the on-route scroll data and eco-guidance symbol layout data is generated (S930). In addition, the eco-guidance symbol layout data is the data that arranges the eco-guidance symbols of an acceleration mark, a deceleration mark, a lane-change mark, a shift position change mark, a window opening and closing mark, an uphill slope/downhill slope mark, a speed mark, and an acceleration section/deceleration section on the display screen besides the starting point, destination and searched route after setting the destination and the performing the route search when the on-route scroll with the eco-guidance is performed based on the on-route scroll data. Then, the process waits until the processing is completed (S935), and upon completing the processing (S935:YES), the data is transmitted to the navigation apparatus 10 (S950), and the processing is finished.

On the other hand, the memorized ideal value in the eco-driving information database 330 is converted based on the additional information and environmental information when the environmental information of every area is determined to be available (S925:YES), and the on-route scroll data and eco-guidance symbol layout data are generated (S940). Then, the process waits until the processing is completed (S945), and upon completing the processing (S945:YES), the data is transmitted to the navigation apparatus 10 (S950), and the processing is finished.

In addition, when the control circuit 108 in the navigation system 10 receives information transmitted from the center 320 in response to the above request, the display unit 110 of the navigation apparatus 10 displays the received information, or the external memory 109 of the navigation apparatus 10 stores the received information.

### [Real-Time Eco-Route Guidance Processing]

A flowchart of FIG. 14 is referred to for describing the real-time eco-route guidance processing that the center 320 carries out. The processing of the real-time eco-route guidance is repeated when the center 320 has electricity supply.

In addition, the real-time eco-route guidance processing acquires fuel mileage information and vehicle information when the vehicle travels without requesting “eco-driving on-route scroll” instructions to the center 320, and the processing compares the acquired travel data of the vehicle with the actual travel data that is registered to the center 320 for instructing the eco-driving. In other words, when a vehicle actually travels a road, it is impossible to instruct the eco-driving all the way in an ideal state from the departure spot to the destination because the vehicle is susceptible to the traffic light stop, the travel condition of other vehicle, or detour from the expected navigation route. Therefore, the eco-driving instruction is cancelled (including temporal cancellation) when the actual travel condition is too diverted from the ideal one, or the eco-driving instruction display is stopped (that is, the vehicle position mark and the eco mark are superposed) at the stopped position until the vehicle returns to the ideal eco-driving condition if the vehicle has stopped. In addition, the eco-guidance symbol may be continuously displayed only for the highway, a high-standard road or the like that does not have affecting conditions such as the traffic signals and other vehicle's travel conditions, with the cancellation of the eco-guidance symbol for the other roads.

That is, the process determines whether it is requested to generate the on-route scroll data from the navigation apparatus 10 (S1005). The process waits until it is requested to generate the on-route scroll data from the navigation apparatus 10 (S1005:NO), and upon determining that generating the on-route scroll data is requested from the navigation apparatus 10 (S1005:YES), the process determines whether it is requested to provide the real-time eco-route guidance (S1010). The real-time eco-route guidance is the guidance that displays the eco-driving information about the current position of the vehicle besides providing the route guidance according to the travel of the vehicle. The process waits until it is requested to perform the real-time eco-route guidance (S110:NO), and upon determining that the real time eco-route guidance is requested (S110:YES), the process determines whether it is requested to stop the real time eco-route guidance (S1015). When it is determined that the stop of the real-time eco-route guidance is requested (S1015:YES), the real-time eco-route guidance is canceled (S1035), and the processing is finished.

On the other hand, when it is determined that the stop of the real-time eco-route guidance is not requested (S1015:NO), it is determined whether there is difference of equal to more than a predetermined time between the ideal eco-driving condition and the predetermined value (S1020). In addition, the predetermined time and the predetermined value are set beforehand by experiments for each of the determination criteria for determining the ideal eco-driving condition. When there is a deference of predetermined time or greater between the eco-route driving condition and the predetermined value (S1020:YES), the vehicle 340 is assumed to be traveling out of the navigation route, thereby canceling the real-time eco-route guidance (S1040), and the process is returned to S1015. On the other hand, when a difference between the ideal eco-driving condition and the predetermined value is not equal to or greater than the predetermined time (S1020:NO), the process determines whether the vehicle's travel is stopped (S1025).

When it is determined that the vehicle is traveling, that is, the vehicle is not stopping (S1025:NO), the process determined whether the vehicle has arrived at the destination (S1030). When it is determined that the vehicle 340 has not arrived at the destination (S1030:NO), the process returns to S1015. On the other hand, when it is determined that the vehicle 340 has arrived at the destination (S1030:YES), the real-time eco-route guidance is canceled (S1035), and the processing is finished.

On the other hand, when it is determined that the travel of the vehicle is stopped (S1025:YES), the real-time eco-route guidance is stopped (S1045), and the process determines whether the travel condition of the vehicle 340 has reached the ideal eco-driving condition (S1050). When it is determined that the travel condition of the vehicle 340 has not reached the ideal eco-driving condition (S1050:NO), the process returns to S1045. On the other hand, when it is determined that the travel condition of the vehicle 340 has reached the ideal eco-driving condition (S1050:YES), the real time eco-route guidance is resumed (S1055), and the process returns to S1015.

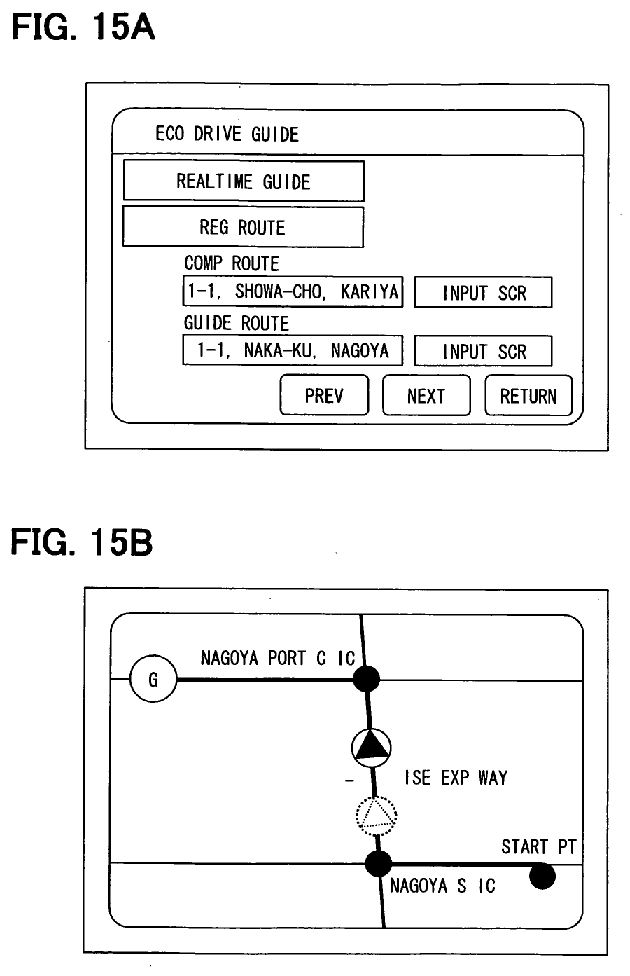

The following description describes an example. That is, when the eco-driving support screen in FIG. 7A is shown on the display unit 110, an eco-driving instruction screen as shown in FIG. 15A is displayed upon pressing a “real-time guide” button. Now, after setting the comparison route and the guide route that is a subject route for the eco-driving instruction and pressing “registered route” button, the display screen of the eco-driving instruction is displayed as shown in FIG. 15B, and the eco-driving instruction is started. If an “input screen” button of the comparison route portion is pressed at this point, the display screen of the search results of the eco-route registration data in FIG. 9A is displayed on the display unit 110. If an “input screen” button of the guide route portion is pressed, the display screen of the search results of the eco-route in FIG. 8A is displayed on the display unit 110.

In addition, when a standard setting or a processing in the center 320 is not performed for the “real-time guide” button or the “registered route” button, the driving instruction is not performed as a result of “Tone-down.” In addition, the display screen of the eco-route search results in FIG. 8A can instruct the center 320 to calculate the ideal eco-driving route. The calculated ideal eco-driving route and the actual travel data can be compared by acquiring the fuel mileage information and vehicle information during the travel of the vehicle without requesting the center 320 for the eco-driving on-route scroll instruction. The comparison between the ideal eco-driving data and the actual travel data can be compared afterwords.

In addition, when the navigation apparatus has received the information from the center 320 in response to the above request, the received information is displayed on the display unit 110 or is stored to the external memory 109.

### Advantageous Effects of the Present Embodiment

(1) Because the control circuit 108 controls the display unit 110 to display a part of the route with the relevant eco-driving information in the on-route scroll process, and the route map is scrolled with its virtual moving point for guiding the route matched with a standard point (e.g., a center point) of the display unit 110, the user can recognize the relevant eco-driving information prior to the actual driving of the route during a route checking process. Therefore, the user can imagine effective operations for each portion of the route that is to be traveled prior to the actual travel.

(2) In addition, when the scale of the route map is large, the eco-driving information guidance screen is displayed on the display unit 110 as shown in FIG. 6A for showing the eco-driving required portion of the route in a different color with the eco-driving instruction contents (average speed, acceleration/deceleration information) represented by text and voice. Therefore, the eco-driving information of the higher priority may only be displayed on the display unit 110 in an emphasized manner prior to the actual driving for the ease of the recognition by the user.

(3) Further, when the scale of the route map is small, the eco-driving information guidance screen is displayed on the display unit 110 as shown in FIG. 6B for showing a detailed guidance map when the vehicle mark approaches the eco-driving guidance point or for increasing the scale of the guidance map. In addition, depending on the scroll speed of the on-route scroll, the eco-driving instruction method may be changed. That is, for example, the spot of higher priority (a point where the fuel mileage may be steeply deteriorated depending on the driving method) may only be guided when the on-route scroll speed is fast. In the above-described manner, the portion of the route that has the eco-driving information is emphasized in comparison to other portions of the route, thereby enabling the user to easily recognize the eco-driving information of the route prior to the actual travel of the route.

(4) Furthermore, when the average speed or acceleration is included in the eco-driving information of the on-route scroll process of the navigation apparatus 10, the scrolling display of the vehicle position is controlled to be matched with the average speed or the acceleration. In this manner, the moving point is always put at a substantially centered position of the display unit 110, thereby enabling the easy recognition of the driving support information by the user's eye.

(5) Furthermore, the on-route scroll with the eco-guidance is selected in the navigation apparatus 10 of the present embodiment, the guidance map as shown in FIG. 5 is displayed on the display unit 110, and various “eco-guidance symbols” are display on the display screen of the guidance map. The symbols includes an acceleration mark, a deceleration mark, a lane-changing mark, a shift position change mark, a window opening and closing mark, an uphill slope/downhill slope mark, a speed mark, an acceleration section/deceleration section are displayed besides the starting point/destination after setting the destination and performing the route search. That is, by displaying the eco-driving information in symbolic representation, quicker understanding of the present eco-driving information relative to the text representation is achieved for the ease of recognition by the user prior to the actual travel of the route.

### OTHER EMBODIMENTS

Though the present invention is fully explained in the above description, various modifications may be considered relevant to the present invention in addition to the above embodiment. For example;

(1) In the on-route scroll processing, the control circuit 108 may change the color of the position where the mileage turns worse among from the other positions of the route for emphasized display on the display unit 110. The emphasis may take a form of display color change, text font change, thickening the text/line of the relevant portion or the like. In this manner, the ease of the recognition by the user prior to the actual travel is facilitated.

(2) Without regard to the selection of the eco-guidance on-route scroll, the eco-guidance symbol may be displayed on the guidance map. In this manner, the eco-driving information may be displayed as a symbol for facilitating the quick recognition by the user in comparison to the eco-driving information provided by using text.

(3) The difference of the fuel mileage between the actual travel and the eco-driving information may be calculated and emphasized on the display when the difference value is greater than the predetermined value. In this manner, the driving operation of a certain route can be examined and the result of the examination can be utilized for the driving of the same portion of the route later in the subsequent travel. The emphasized portion can be easily recognized by the user in the display screen.

(4) The actual driving history of the user and/or the eco-driving information may be displayed as symbols on the display. In this manner, the user's driving history and/or the eco-driving information can be more easily recognized in comparison to the information provided by the text on the display.

(5) The degree of the eco-driving and safeness of the driving method of a user may be evaluated and examined for improvement of the driving method of the user. The user may have a feedback of the evaluation in a form of an eco-point that can be collected as an incentive for a higher evaluation point or the like.

Such changes and modifications are to be understood as being within the scope of the present invention as defined by the appended claims.

What is claimed is:

1. A route display apparatus comprising:
an information acquisition unit capable of acquiring route information and driving support information, wherein the route information determines a specific route and the driving support information contributes to an efficient driving;
a display unit capable of displaying various information; and
a control unit capable of displaying a route map and scrolling the route map, wherein
the route map is partially displayed by the control unit on the display unit for displaying the specific route that is determined based on the route information acquired by the information acquisition unit,
the route map is displayed by the control unit in association with the driving support information acquired by the information acquisition unit, and
the scrolling of the route map is controlled by the control unit so that a virtual moving point that moves along the specific route and a standard point on the display unit are matched in a course of scrolling the route map.

2. The route display apparatus of claim 1, wherein
the control unit selectively displays on the display unit the driving support information that has a higher priority relative to a threshold when a scroll speed of the route map is greater than a predetermined value in the course of the scrolling.

3. The route display apparatus of claim 1, wherein
the control unit displays on the display unit a reduced scale display image in a rectangular shape that at least includes the standard point on the display unit and the driving support information together with the route map after generating the reduced scale display image when a scale of the route map is greater than a threshold in the course of scrolling.

4. The route display apparatus of claim 1, wherein
the control unit displays the driving support information including a deterioration of fuel mileage in a traveling time in an emphasized manner in the course of scrolling.

5. The route display apparatus of claim 1, wherein
the control unit scrolls the route map in a corresponding manner to a travel speed or an acceleration when the driving support information displayed in a proximity of the standard point includes the travel speed or the acceleration in the course of scrolling.

6. The route display apparatus of claim 1, wherein
the control unit displays the driving support information as an icon on the display unit in the course of scrolling.

7. The route display apparatus of claim 1, wherein
the control unit acquires an actual fuel mileage of a part of the specific route when the route is actually traveled,
the control unit calculates a difference between the acquired fuel mileage and the fuel mileage in the driving support information that relates to the specific route, and
the control unit displays on the display unit the specific route in an emphasized manner when the calculated difference is greater than a threshold.

8. The route display apparatus of claim 1, wherein
the control unit acquires driving history information that represents an actual travel of a part of the specific route,
the control unit displays the driving history information as an icon on the display unit, and
the control unit displays the driving support information regarding the specific route as an icon on the display unit.

9. The route display apparatus of claim 1 further comprising:
an information storage unit capable of storing the route information and the driving support information, wherein
the information acquisition unit acquires the route information and the driving support information from the information storage.

10. A route display system comprising:
the route display apparatus of claim 1; and
an information center, wherein
the route display apparatus and the information center communicate with each other,
the information center has an information storage that is capable of storing the route information and the driving support information,
the information storage of the route display apparatus acquires the route information and the driving support information from the information storage of the information center.
